(19) United States
(12) Patent Application Publication
(10) Pub. No.: US 2018/0218454 A1
(43) Pub. Date: Aug. 2, 2018

(54) MANAGING PARTICIPATION IN A MONITORED SYSTEM USING BLOCKCHAIN TECHNOLOGY

(71) Applicant: Walmart Apollo, LLC, Bentonville, AR (US)

(72) Inventors: John Simon, Bentonville, AR (US); Donald Ray High, Noel, MO (US); Bruce Wilkinson, Rogers, AR (US); Todd Mattingly, Bentonville, AR (US); Robert Cantrell, Herndon, VA (US); John Jeremiah O'Brien, V, Farmington, AR (US); Brian McHale, Oldham (GB); Joseph Jurich, JR., Molino, FL (US)

(21) Appl. No.: 15/881,715

(22) Filed: Jan. 26, 2018

Related U.S. Application Data
(60) Provisional application No. 62/451,424, filed on Jan. 27, 2017.

(51) Int. Cl. G06Q 40/08; H04L 9/06

(52) U.S. Cl. CPC G06Q 40/08; H04L 9/0618

(57) ABSTRACT

Examples of the disclosure provide systems and methods for managing participation in a monitored system. A system identifies an asset associated with trigger data and authorization data. The trigger data is associated with triggers configured to execute on condition that parameters are satisfied, and the authorization data is associated with an authorization of members to perform tasks. A transaction request associated with a transfer of the asset is transmitted to a network, and a validation notification is received from the network. On condition that the first parameter is satisfied, a validation notification associated with a transfer of another asset between the participant and the member is received from the network. On condition that the second parameter is satisfied, a validation notification associated with another transfer of the asset between the participant and the first member is received from the network.

### BACKGROUND

Intermediary systems may be used to facilitate transactions. Premium payments and/or claims for a protection mechanism (e.g., insurance policy), for example, may be processed using an intermediary system. At least some known intermediary systems generate transaction data that enables a transaction history of the protection mechanism to be created. Transaction data may indicate, for example, that a premium payment and/or claim had been made. The transaction data generated using at least some known intermediary systems, however, is limited.

### SUMMARY

Examples of the disclosure provide a computer-implemented method for managing participation in a monitored system. The computer-implemented method includes obtaining a transaction request associated with a first transfer of a first asset between a participant and a system registrar of the monitored system. The first asset includes event condition data and authorization data. The event condition action data is associated with a first trigger configured to execute on condition that a predetermined first parameter is satisfied and a second trigger configured to execute on condition that a predetermined second parameter is satisfied. The authorization data is associated with an authorization of one or more members of the monitored system to perform one or more authorized tasks. The method further includes communicating with one or more nodes in a network to validate a transaction associated with the first transfer of the first asset. Upon identifying that the predetermined first parameter is satisfied, the first trigger is executed to perform one or more first triggered actions including communicating with the nodes in the network to validate a first triggered transaction associated with a transfer of a second asset between the participant and a first member of the members. Upon identifying that the predetermined second parameter is satisfied, the second trigger is executed to perform one or more second triggered actions including communicating with the nodes in the network to validate a second triggered transaction associated with a second transfer of the first asset between the participant and the system registrar. The second transfer is associated with a revocation of the authorization.

In another aspect, a computing system is provided for managing participation in a monitored system. The computing system includes a memory device storing data associated with a participant and computer-executable instructions, and a processor configured to execute the computer-executable instructions. The computer-executable instructions are executed to identify a first asset associated with event condition action data and authorization data. The event condition action data is associated with a first trigger configured to execute on condition that a predetermined first parameter is satisfied and a second trigger configured to execute on condition that a predetermined second parameter is satisfied. The authorization data is associated with an authorization of one or more members of the monitored system to perform one or more authorized tasks. The computer-executable instructions are further executed to identify a network including one or more nodes, transmit a transaction request associated with a first transfer of the first asset between the participant and a system registrar associated with the monitored system to the nodes, and receive a response to the transaction request including a first validation notification associated with the first transfer of the first asset from the nodes. On condition that the predetermined first parameter is satisfied, a second validation notification associated with a transfer of a second asset between the participant and a first member of the members is received from the nodes. On condition that the predetermined second parameter is satisfied, a third validation notification associated with a second transfer of the first asset between the participant and the first member is received from the nodes.

In yet another aspect, one or more computer storage media embodied with computer-executable instructions are provided. The computer storage media include a client component, a consensus component, a manager component, and a plurality of trigger components. The client component receives a transaction request associated with a first transfer of a first asset between a participant and a system registrar, and transmits a response to the transaction request. The consensus component generates a local instance of the transaction request, transmits the local instance of the transaction request to one or more nodes in a network, receives one or more remote instances of the transaction request from the nodes in the network, and implements a consensus protocol to validate a transaction associated with the first transfer of the first asset. The manager component associates the first asset with a user account associated with the participant. The first asset includes authorization data associated with an authorization of one or more members of a monitored system to perform one or more authorized tasks. A first trigger component monitors the user account associated with the participant, and, if a first triggering event is detected, determines whether a transfer of a second asset between the participant and a first member of the members is to be performed for enforcing the monitored system. A second trigger component monitors a time-based parameter, and, if a second triggering event is detected, determines whether a second transfer of the first asset between the participant and the system registrar is to be performed for revoking the authorization of the members to perform the authorized tasks.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram illustrating an example system for managing participation in one or more monitored systems using a computing device.

FIG. 2 is a block diagram illustrating an example participation management environment that may be used with a computing device, such as the computing device shown in FIG. 1.

FIG. 3 is a block diagram illustrating an example participation management environment operating as a cloud-based service.

FIG. 4 is a block diagram illustrating an example participation management environment operating as a cloud-based service using a distributed network.

FIG. 5 is a flowchart illustrating an example method for managing participation using a computing device, such as the computing device shown in FIG. 1.

FIG. 6 is a sequence diagram illustrating an example method for managing participation using a computing device, such as the computing device shown in FIG. 1.

FIG. 7 is a sequence diagram illustrating an example method for managing participation using a distributed network, such as the distributed network shown in FIG. 4.

FIG. 8 is a block diagram illustrating an example operating environment for a computing device, such as the computing device shown in FIG. 1.

Corresponding reference characters indicate corresponding parts throughout the drawings.

### DETAILED DESCRIPTION

Referring to the figures, examples of the disclosure enable participation in a monitored system to be controlled or managed. Blockchain technology, for example, may be used to facilitate the control and/or management of data associated with a participant. A blockchain may be used as a public ledger including an ordered and timestamped record of transactions. The examples described herein enable a participant to give consent to be monitored, and one or more members of the monitored system to perform one or more authorized transactions in accordance with authorization data.

Aspects of the disclosure provide for a computing device that performs one or more operations in an environment including a plurality of devices coupled to each other via a network (e.g., a local area network (LAN), a wide area network (WAN), the Internet). For example, a computing device may communicate with one or more other computing devices, including one or more client devices, to facilitate participation management. In some embodiments, the computing device analyzes data associated with a plurality of user devices to facilitate a transaction between a plurality of users associated with the user devices.

The systems and processes described herein may be implemented using computer programming or engineering techniques including computer software, firmware, hardware or a combination or subset thereof. Aspects of the disclosure improve processor security, data integrity, data storage security, data security in networked devices, data transmission security, and/or communication between computing systems by controlling communications and managing access to various accounts using a public key cryptographic system and/or by verifying and validating transaction data using a proof-of-work protocol and a consensus protocol. Additionally, some aspects may improve user experience, user efficiency, and/or user interaction performance by facilitating transactions in an effective and efficient manner. Moreover, some aspects may increase processor speed, improve operating system resource allocation, and/or reduce error rate by automating the processing of large volumes of data.

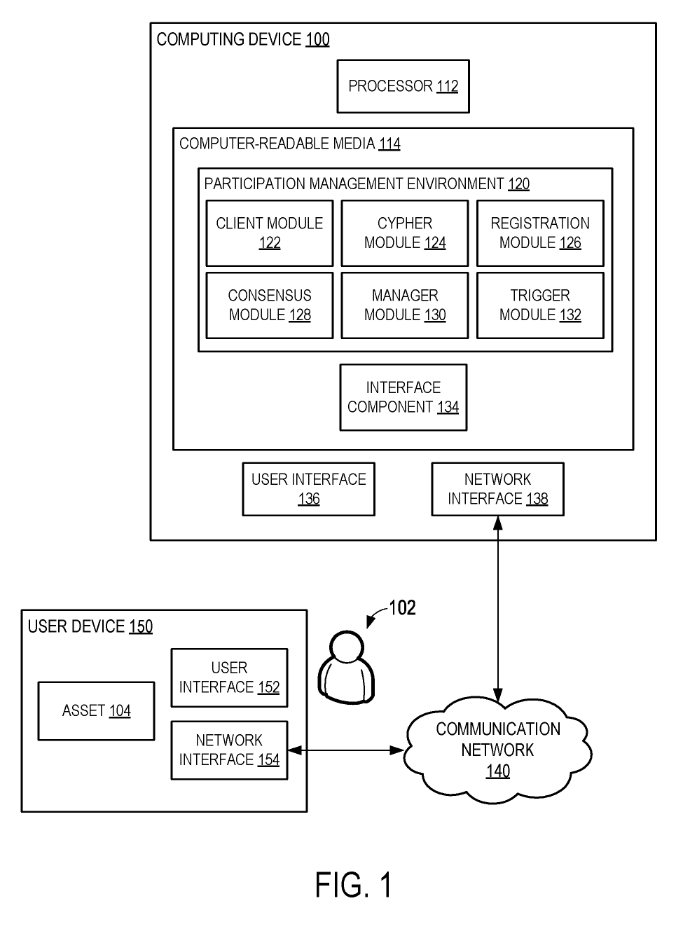

FIG. 1 is a block diagram illustrating an example computing device 100 for managing participation in a monitored system. The computing device 100 represents a system configured to facilitate management of one or more users or participants 102 in a monitored system. As used herein, a user or participant may include, without limitation, a person, an entity, or a device. A device may include a smart device, an autonomous vehicle, a robot, or any other suitable device. In the example of a device, participants 102 may be a provisioned device on a distributed ledger system that has permissions to control or manage the asset 104. The computing device 100 allows the participant 102 to transfer an asset 104. The computing device 100 includes one or more computing systems that execute instructions (e.g., as application programs, operating system functionality, or both) to implement one or more operations as described herein. In some examples, the computing device 100 includes a group of processing units or other computing systems. The computing device 100 may include, for example, a desktop computer, a server computer, a kiosk, a set top box, and/or a tabletop device. Additionally, or alternatively, the computing device 100 may include more-portable computing devices, such as a mobile device, a laptop computer, a tablet device, a netbook, a gaming device, wearables, and/or a portable media player.

In some examples, the computing device 100 has at least one processor 112 and computer-readable media 114. The processor 112 includes any quantity of processing units, and is programmed to execute computer-executable instructions for implementing aspects of the disclosure. The instructions may be performed, for example, by one or more processors 112 within the computing device 100 (as shown in FIG. 1). Additionally, or alternatively, the instructions may be performed by at least one processor external to the computing device 100. The processor 112 may represent an implementation of analog techniques to perform the operations described herein. For example, the operations may be performed by an analog computing device and/or a digital computing device.

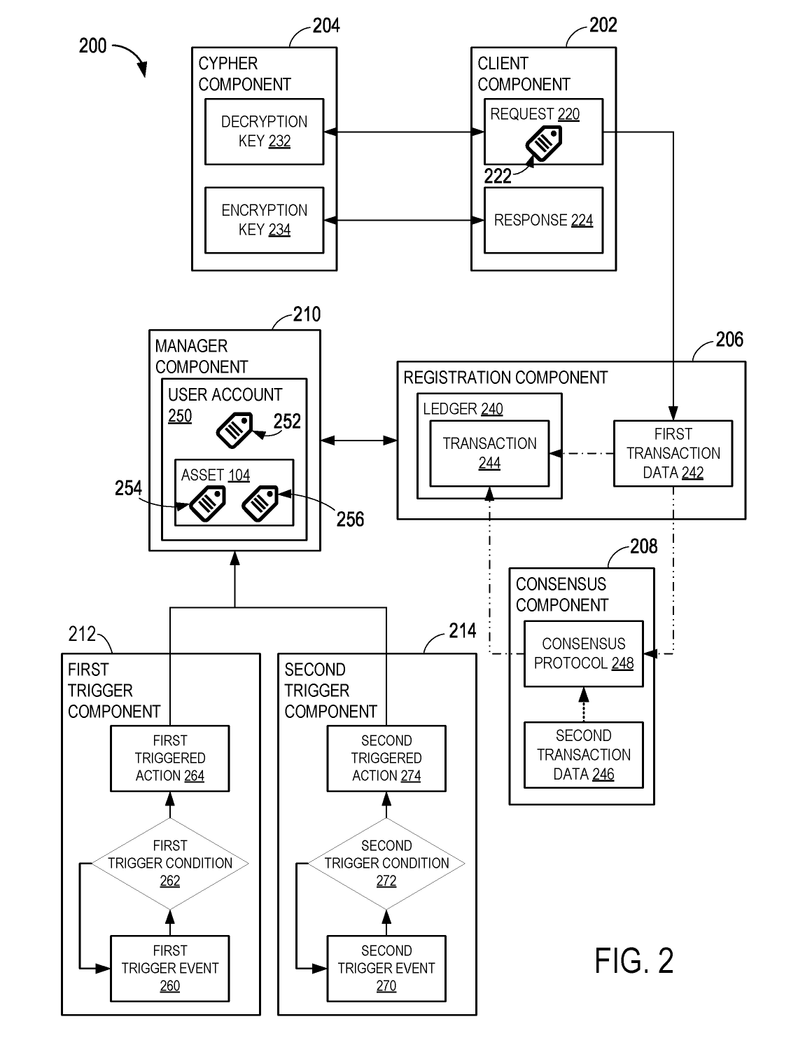

In some examples, the processor 112 is programmed to execute instructions, such as those illustrated in the figures (e.g., FIGS. 2, 5, 6, and 7). The instructions may be stored and/or maintained at the computer-readable media 114. The computer-readable media 114 includes any quantity of media associated with or accessible by the computing device 100. The computer-readable media 114 may be internal to the computing device 100 (as shown in FIG. 1), external to the computing device 100, or both. For example, the computer-readable media 114 may include data stored locally at the computing device 100, data access points stored locally at the computing device 100 and associated with data stored remote from the computing device 100, or any combination of local and remote data. In some examples, the computer-readable media 114 includes read-only memory and/or memory wired into an analog computing device.

The computer-readable media 114 stores and/or maintains, among other data, one or more applications. The applications, when executed by the processor 112, operate to perform one or more operations and/or provide functionality on the computing device 100. Example applications include a participation management environment 120, which may represent an application for facilitating participation management in a monitored system. The participation management environment 120 may provide one or more computer-executable components for managing participation of the participant 102. In some examples, the participation management environment 120 includes a client module 122, a cypher module 124, a registration module 126, a consensus module 128, a manager module 130, and a trigger module 132.

The client module 122 is a component of the participation management environment 120 that identifies one or more transaction requests. The client module 122 is configured to receive and/or identify one or more incoming messages. The incoming messages may be analyzed to determine whether the incoming messages include and/or are associated with a transaction request associated with a transfer of an asset 104. In some examples, the client module 122 is configured to identify and/or locate one or more other computing systems and transmit one or more outgoing messages to the other computing systems. The outgoing messages may be transmitted to one or more computing systems in response to the transaction requests. In some examples, the client module 122 authenticates one or more participants 102 and/or one or more computing systems associated with the participants 102.

The cypher module 124 is a component of the participation management environment 120 that transforms data between a plurality of forms. The cypher module 124 may be used to protect the computing device 100, the participation management environment 120, and/or data transmitted to and/or from the participation management environment 120. The cypher module 124 is configured to convert readily-unintelligible data into readily-intelligible data. A message including encrypted information in cyphertext form, for example, may be decrypted to generate and/or identify information in plaintext form. In some examples, the cypher module 124 is configured to convert readily-intelligible data into readily-unintelligible data. A message including information in plaintext form, for example, may be encrypted to generate and/or identify encrypted information in cyphertext form.

The registration module 126 is a component of the participation management environment 120 that processes one or more transaction requests. The registration module 126 is configured to analyze the transaction requests to determine whether to approve or not approve (e.g., reject) the transaction requests. In some examples, the registration module 126 generates transaction data associated with the transaction requests. Transaction data associated with one or more approved transaction requests may be registered, for example, to enable one or more computing systems to identify and/or locate a transaction associated with the transaction data. Transaction data may include, for example, a transaction identifier, a user identifier, a device identifier, a transaction date, a transaction time, a transaction location, and/or a transaction amount.

The consensus module 128 is a component of the participation management environment 120 that validates one or more transactions associated with one or more transaction requests. The consensus module 128 is configured to determine whether the transaction data associated with the transaction requests is reliable, or at least likely to be reliable. In some examples, the consensus module 128 compares the transaction data with other data to determine whether the other data corroborates or supports the transaction data. The consensus module 128 may determine that the transaction data is reliable, for example, if the other data corroborates or supports the transaction data. One or more transactions associated with one or more transaction requests may be validated on condition that transaction data associated the transaction requests is determined to be reliable.

The manager module 130 is a component of the participation management environment 120 that administers or manages data associated with one or more participants 102 in the monitored system. The manager module 130 is configured to identify the participants 102 and/or one or more computing systems associated with the participants 102, and administers or manages one or more accounts associated with the participants 102. In some examples, the manager module 130 generates and/or modifies profile information associated with the participants 102.

The trigger module 132 is a component of the participation management environment 120 that monitors one or more accounts associated with the participants 102. The trigger module 132 is configured to perform one or more predetermined operations. The predetermined operations may be performed, for example, to facilitate enforcing one or more interests associated with the transactions. For example, the predetermined operations may be used to transfer the asset 104 or one or more other assets associated with the participant 102.

In some examples, the computing device 100 includes an interface component 134 stored and/or maintained at the computer-readable media 114. When executed by the processor 112, the interface component 134 may cause the computing device 100 to perform one or more operations and/or provide functionality that facilitate participation management communication. The interface component 134 may include computer-executable instructions (e.g., a driver) for operating one or more user interfaces 136 and/or network interfaces 138.

A user interface 136, for example, may be used to present information to and/or receive user input from a user of the computing device 100. User interfaces 136 may include any output and/or input device that enables information to be presented to and/or received from the user, such as a display device, a monitor, a touchscreen panel, a graphics card, a speaker, a sound card, a printer, a vibration motor, a natural user interface, a tablet, a microphone, a keyboard, a pointing device, a sensor device, a digital camera, an accelerometer, and the like. The user interfaces 136 may be internal to the computing device 100 (as shown in FIG. 1), external to the computing device 100, or both.

A network interface 138 may be used to transmit data to and/or receive data from one or more other computing systems. Network interfaces 138 may include any output and/or input device that enables information to be presented to and/or received from another computing system, such as a modem, a network interface controller (NIC), a WI-FI® brand local area wireless computing network-enabled device, a BLUETOOTH® brand wireless technology-enabled device, a ZIGBEE® brand wireless technology-enabled device, Z-WAVE™ brand wireless technology-enabled device, and/or an NFC wireless communication-enabled device. The network interfaces 138 may be internal to the computing device 100 (as shown in FIG. 1), external to the computing device 100, or both.

In some examples, one or more applications, such as the participation management environment 120, communicate with counterpart applications or services such as web services accessible via one or more communication networks 140 that enable data to be transferred between a plurality of computing systems coupled to the communication network 140. For example, the applications may represent server-side applications that enable client-side services to be provided at one or more client devices. In some examples, the computing device 100 communicates with a user device 150 (e.g., via the communication network 140) to allow the participant 102 to enter into one or more transactions.

In some examples, the user device 150 provides an instance of the participation management environment 120 (e.g., a client-side application) for presenting information to and/or receiving user input from the participant 102 while participation management operations are performed on the backend at the computing device 100. The user device 150 may include an operating system that enables the instance of the participation management environment 120 to be provided in a user-friendly manner. For example, the operating system may include one or more application program interfaces (APIs) that enable the user device 150 to present information to and/or receive user input from the participant 102 using a user interface 152 and/or transmit data to and/or receive data from one or more other computing systems (e.g., computing device 100) using a network interface 154.

In some examples, user device 150 may be provisioned as a federated entity to be used in hosting and providing a private key of the associated user, such as user 102, to the distributed ledger used to maintain and control the transactions associated with appliance 110. User device 160 may be used to provision and/or deprovision access of appliance 110 to the user's network of devices, in some examples. User device 160 may enable a user to configure customized levels of control and access per device (e.g. appliance 110) using the instance of the appliance management environment 130 implemented on user device 160. Customized levels of control and access may include: limited access, one-time access, full-authority access, specific channels of activity access, and any other suitable control customization. In other examples, user device 160 may be provisioned to provide private key information for authenticating and/or provisioning other devices, but may have restricted management access or otherwise limited authority.

FIG. 2 is a block diagram illustrating an example participation management environment 200 for managing participation in a monitored system. The participation management environment 200 is an example of one implementation of the participation management environment 120 in FIG. 1. The participation management environment 200 includes a client component 202, a cypher component 204, a registration component 206, a consensus component 208, a manager component 210, a first trigger component 212, and a second trigger component 214.

The client component 202 is configured to identify a transaction request 220 associated with a transfer of an asset 104. The client component 202 may communicate with one or more other computing systems (e.g., user device 150) to receive one or more messages. In some examples, the client component 202 processes or analyzes a message to determine whether the message is, includes, or is associated with a transaction request 220. For example, a message including one or more identifiers 222 may be interpreted and/or identified as a transaction request 220. Example identifiers 222 include a transaction identifier, an asset identifier, a user identifier, and the like.

In some examples, the client component 202 communicates with the user device 150 to transmit one or more messages. For example, the client component 202 may transmit a response 224 to a transaction request 220 received from the user device 150. In some examples, the client component 202 analyzes the transaction request 220 to generate the response 224. Additionally, or alternatively, the client component 202 may analyze the transaction request 220 to identify and/or locate the user device 150. In some examples, the user device 150 may be identified and/or located using one or more identifiers 222 included in or associated with the transaction request 220.

The cypher component 204 is configured to transform data between a readily-unintelligible form and readily-intelligible form. The cypher component 204 may communicate with the client component 202 to obtain one or more encrypted messages received from the user device 150, such as an encrypted transaction request 220. In some examples, the cypher component 204 processes or analyzes an encrypted message using a decryption key 232 to generate intelligible information (e.g., in plaintext form) corresponding to the encrypted message.

In some examples, the cypher component 204 communicates with the client component 202 to provide one or more encrypted messages for transmission to the user device 150. For example, the cypher component 204 may process a response 224 using an encryption key 234 to generate unintelligible data (e.g., in cyphertext form) corresponding to the response 224 (e.g., an encrypted response 224), and communicate with the client component 202 for transmitting the encoded response 224 to the user device 150.

The registration component 206 is configured to maintain or manage a record or ledger 240. The ledger 240 enables data associated with one or more participants 102 to be monitored and managed. The registration component 206 may communicate with the client component 202 and/or cypher component 204 to obtain one or more transaction requests 220. In some examples, the registration component 206 processes or analyzes the transaction request 220 to identify and/or generate first transaction data 242 associated with the transaction request 220. The first transaction data 242 may be used to determine whether to approve or not approve the transaction request 220 and/or whether to record or register the first transaction data 242 in the ledger 240.

In some examples, the registration component 206 determines whether the asset 104 associated with the transaction request 220 is legitimate, whether the participant 102 associated with the transaction request 220 is legitimate or authorized to enter into a transaction associated with a transfer of the asset 104, and/or whether the participant 102 agrees to enter into the transaction. If the asset 104 is not legitimate, the participant 102 is not authorized (e.g., unauthorized), and/or the participant 102 does not agree, the registration component 206 does not approve the transaction request 220 and/or does not register the first transaction data 242 in the ledger 240. On the other hand, if the asset 104 is legitimate, the participant 102 is authorized, and the participant 102 agrees, the registration component 206 approves the transaction request 220 and/or registers the first transaction data 242 in the ledger 240.

The consensus component 208 is configured to validate a transaction 244 associated with the transaction request 220. The consensus component 208 may communicate with the registration component 206 to obtain first transaction data 242 associated with the transaction request 220. Additionally, the consensus component 208 may communicate with one or more other computing systems to determine whether the first transaction data 242 is reliable. In some examples, the consensus component 208 transmits the first transaction data 242 (e.g., a local instance of the transaction request 220) to the other computing systems and/or receive second transaction data 246 associated with the transaction request 220 (e.g., one or more remote instances of the transaction request 220) from the other computing systems.

If the first transaction data 242 is the same as or consistent with the second transaction data 246 (e.g., if the second transaction data 246 corroborates or supports the first transaction data 242), the consensus component 208 validates the transaction 244 using the first transaction data 242 and/or the second transaction data 246. On the other hand, if the first transaction data 242 is inconsistent (e.g., conflicts) with the second transaction data 246, the consensus component 208 settles or reconciles one or more inconsistencies between the first transaction data 242 and the second transaction data 246, and validates the transaction 244 using the reconciled transaction data (e.g., first transaction data 242, second transaction data 246, or other transaction data). The inconsistencies may be settled, for example, using a consensus protocol 248.

The manager component 210 is configured to administer or manage data associated with one or more participants 102 in the monitored system. The manager component 210 may communicate with the registration component 206 to identify one or more participants 102 associated with the transaction 244, and administer or manage one or more user accounts 250 associated with the participants 102. A user account 250 includes account data, such as one or more user identifiers 252. The user identifiers 252 includes any data that enables a user (e.g., participant 102) to be identified and/or authenticated. Example user identifiers 252 include usernames, identification numbers, serial numbers, media access controller (MAC) addresses, Uniform Resource Identifiers (URIs), public key infrastructure (PM) certificates, BLUETOOTH® brand wireless technology identifiers, ZIGBEE® brand wireless technology identifiers, Z-WAVE™ brand wireless technology identifiers, Internet protocol (IP) addresses, NFC identifiers, RFID identifiers, phone numbers, email addresses, mailing addresses, security tokens, passwords, personal identification numbers (PINs), signatures, voiceprints, body postures or gestures, biometric data, and the like.

In some examples, the manager component 210 analyzes the first transaction data 242 and/or second transaction data 246 to identify the participant 102 and the asset 104, and associate the asset 104 with a user account 250 associated with the participant 102. The asset 104 includes authorization data 254 indicative of the participant's consent to be monitored. Authorization data 254 may be associated with, for example, an authorization of one or more members of the monitored system to perform one or more authorized tasks.

The first trigger component 212 is configured to monitor the user account 250 associated with the participant 102. The first trigger component 212 may communicate with the manager component 210 to enable the manager component 210 to administer or manage the user account 250 in accordance with the authorization data 254. For example, in addition to the authorization data 254, the asset 104 may include trigger or event condition action data 256 that defines at least some parameters associated with the authorization data 254. In some examples, the first trigger component 212 may evaluate an event-based condition (e.g., an occurrence), a location-based condition (e.g., a proximity), and/or a time-based condition (e.g., a timeframe).

Event condition action data 256 may be used, for example, to detect and/or identify an occurrence of a predetermined first triggering event 260. In some examples, the first trigger component 212 communicates with the registration component 206 to identify one or more first triggering events 260 associated with the event condition action data 256. Example first triggering events 260 may include, without limitation, a change in insurance policy status, a change in driver's license status, a change in financial account status, a traffic accident, an airbag deployment, an accusation of a violation of law, a court decision, a probation violation, a parole violation, a drug test, and the like.

Upon identification of the occurrence of the first triggering event 260, the first trigger component 212 evaluates one or more predetermined first trigger conditions 262 to determine whether to perform one or more predetermined first triggered actions 264. Example first trigger conditions 262 may include an insurance policy status (e.g., in force, lapsed), a driver's license status (e.g., valid, suspended, revoked), a financial account status (e.g., open, closed, charged-off), a court sentence (e.g., absolute discharge, probation order, fine, imprisonment), a drug test result (e.g., positive, negative), or any other suitable condition.

If the first trigger conditions 262 are satisfied, the first trigger component 212 performs the first triggered actions 264. For example, the first trigger component 212 may communicate with the registration component 206 to enter into one or more transactions associated with one or more transfers of one or more assets (e.g., asset 104). In some examples, the first trigger component 212 allows or authorizes one or more members of the monitored system to perform one or more authorized tasks in accordance with the authorization data 254. For example, an insurer may modify, buyback, or annul a protection mechanism (e.g., insurance policy), and/or a government entity may suspend or revoke a driver's license associated with the participant 102, issue a citation or ticket, issue a charging document (e.g., complaint, information, indictment), and/or issue a court decision. Example government entities may include a Department of Motor Vehicles (DMV), a Department of Transportation (DoT), a law enforcement agency, a court of law, a prosecutor's office, and the like. As another example, a fleet management system stored on the distributed ledger system may automatically provision or deprovision vehicles from a fleet. A fleet vehicle may include any type of vehicle, such as, without limitation, unmanned aerial vehicles (UAVs), automated guided vehicles (AGVs), transportation vehicles, robotic vehicles, and the like. As yet another example, device management systems may automatically provision or deprovision network devices detected. On the other hand, if the first trigger conditions 262 are not satisfied, the first trigger component 212 continues to monitor the user account 250 in accordance with the authorization data 254.

The second trigger component 214 is configured to monitor a time-based parameter associated with the authorization data 254. The second trigger component 214 may communicate with the manager component 210 to enable the manager component 210 to administer or manage the user account 250 in accordance with the authorization data 254. Event condition action data 256 may also be used to detect and/or identify an occurrence of a predetermined second triggering event 270. In some examples, the second trigger component 214 communicates with the registration component 206 to identify one or more second triggering events 270 associated with the event condition action data 256. Example second triggering events 270 may include, without limitation, a change in user device connection status, a change in insurance policy status, a change in driver's license status, and the like.

Upon identification of the occurrence of the second triggering event 270, the second trigger component 214 evaluates one or more predetermined second trigger conditions 272 to determine whether to perform one or more predetermined second triggered actions 274. If the second trigger conditions 272 are not satisfied, the second trigger component 214 continues to monitor the user account 250 in accordance with the authorization data 254. Example second trigger conditions 272 may include an insurance policy status, a driver's license status, a court sentence, a drug test result, and the like. If the second trigger conditions 272 are satisfied, the second trigger component 214 performs the second triggered actions 274. For example, the second trigger component 214 may communicate with the registration component 206 to enter into one or more transactions associated with one or more transfers of the asset 104 and/or of one or more other assets (e.g., second assets). In some examples, the second trigger component 214 terminates or revokes the authorization of the members of the monitored system to perform one or more authorized tasks. On the other hand, if the second trigger conditions 272 are not satisfied, the second trigger component 214 continues to monitor the user account 250 in accordance with the authorization data 254.

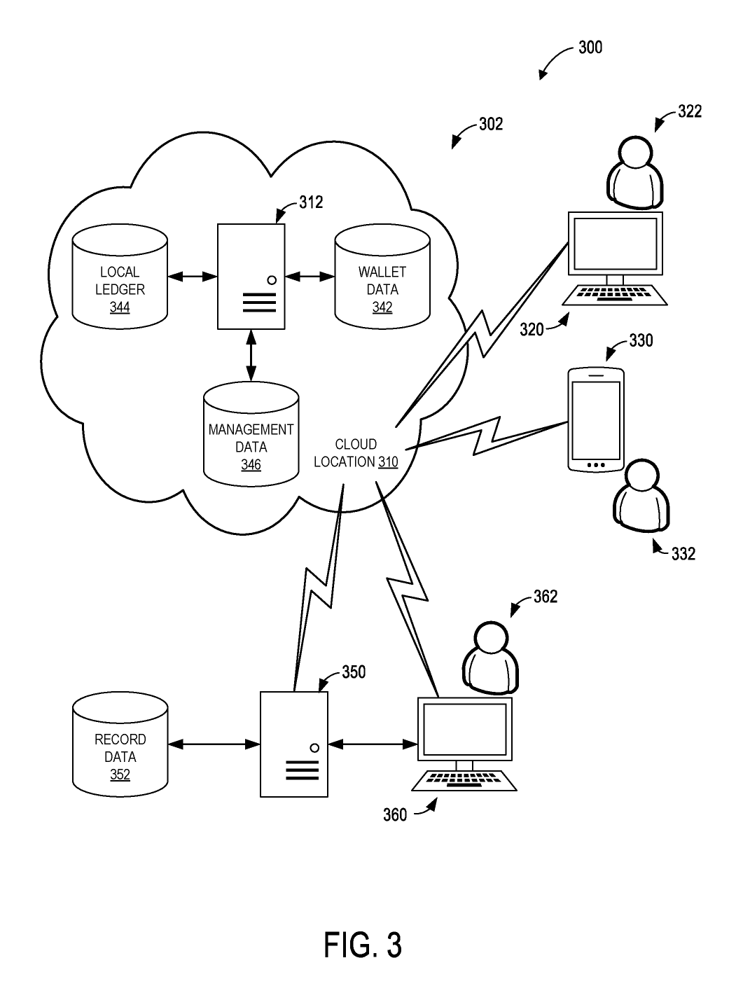

FIG. 3 is a block diagram illustrating an example participation management environment 300 operating as a cloud-based service. The participation management environment 300 may be an illustrative example of the participation management environment 120 in FIG. 1 and/or the participation management environment 200 in FIG. 2. The participation management environment 300 may be implemented in a cloud-based environment with one or more operations performed in the cloud. The participation management environment 300 includes a cloud location 310 at which one or more participation management operations, such as those depicted in FIGS. 2, 5, 6, and 7, may be performed.

One or more client devices (e.g., user device 150) may be communicatively coupled to the cloud location 310 via a communication network (e.g., communication network 140) or other network for participating in a monitored system. The cloud location 310 includes a server system 312 (e.g., computing device 100) that uses one or more server-side applications to provide one or more client-side services at the user devices 150. Additionally, or alternatively, the user devices 150 may use one or more client-side applications to present information to and/or receive user input from one or more users (e.g., participant 102) while participation management operations are performed on the backend at the cloud location 310.

A first client device 320 of the client devices allows a first user 322 (e.g., a system registrar) to monitor another user to manage participation of the other user in the monitored system. The first user 322 may communicate with a second client device 330 associated with a second user 332 (e.g., participant 102) using the first client device 320. In some examples, the first user 322 obtains information from and/or provides information to the second user 332 through a direct communication link between the first client device 320 and the second client device 330. That is, the first client device 320 may direct communication data toward the second client device 330, and/or the second client device 330 may direct communication data toward the first client device 320 (e.g., via the communication network 140). Alternatively, the first client device 320 and/or second client device 330 may direct communication data toward the cloud location 310 (e.g., the server system 312), where the communication may be re-directed toward and/or be available to be retrieved by a desired recipient.

In some examples, the first client device 320 and/or second client device 330 generates a transaction request 220 associated with a transfer of an asset 104 between the first user 322 and second user 332. The transaction request 220 may be generated using wallet data 342. Wallet data 342 enables a user (e.g., first user 322, second user 332) to obtain information from and/or provide information to the cloud location 310 using a user device 150 (e.g., first client device 320, second client device 330) for participating in the monitored system. For example, wallet data 342 may be used to implement an authentication protocol for establishing one or more secure communication links between the cloud location 310 and the first client device 320 and/or second client device 330. Wallet data 342 may include a private key, public key, representation of a key (e.g., an encrypted key, a hash, an encrypted hash), and/or link to a key associated with the first user 322 and/or second user 332. In some examples, wallet data 342 is stored and/or maintained at the cloud location 310 (as shown in FIG. 3). Additionally, or alternatively, the wallet data 342 may be stored and/or maintained at the first client device 320 and/or second client device 330.

The transaction request 220 may be transmitted to the server system 312 for processing. The server system 312 processes or analyzes the transaction request 220 to generate first transaction data 242 associated with a transfer of the asset 104 between the first user 322 and second user 332, and stores and/or maintains the first transaction data 242 at a local ledger 344. The server system 312 analyzes the first transaction data 242 to identify the asset 104 and the second user 332, identifies an account associated with the second user 332 (e.g., user account 250), and associates the asset 104 with the account. In some examples, the server system 312 validates a transaction 244 associated with the first transaction data 242.

The server system 312 generates management data 346 that may be used to administer or manage the user account 250 in accordance with authorization data 254. The management data 346 may be generated using authorization data 254 and event condition action data 256 associated with the asset 104. In some examples, the server system 312 uses the management data 346 to communicate with one or more record systems 350 that store and/or maintain record data 352 associated with the second user 332 to receive or retrieve the record data 352 from the record systems 350. Record data 352 may be obtained in accordance with user consent given by the second user 322 (e.g., authorization data 254) and with any laws and regulations regulating the dissemination and legal use of the record data 352, such as the Fair Credit Reporting Act (FCRA), Health Insurance Portability and Accountability Act (HIPAA), Electronic Communications Privacy Act (ECPA), and the like. Example record data 352 may include, without limitation, driving records, vehicle history reports, claims-information reports, law enforcement records, court records, credit reports, and the like. In some examples, the server system 312 uses record data 352 to generate and/or modify management data 346. Record data 352 may be used to identify information such as, for example, an insurance policy status, an insurance policy expiration date, a driver's license status, a driver's license expiration date, a financial account status, a traffic accident, an airbag deployment, an accusation of a violation of law, a court decision, a court decision issuance date, a probation violation, a parole violation, a drug test, and the like.

The management data 346 may also be used to determine whether to approve or decline a request for authorization to access and/or use account data associated with the user account 250. In some examples, the server system 312 receives a request for authorization from the second client device 330. Additionally, or alternatively, the server system 312 may receive a request for authorization from a client device associated with a user other than the second user 332, such as the first client device 320 and/or a third client device 360 associated with a third user 362. The third user 362 may be a member of the monitored system. In some examples, the third user 362 is associated with a record system 350, and/or the third client device 360 is communicatively coupled to the record system 350 (as shown in FIG. 3). Alternatively, the third user 362 may be a member of the monitored system that is not directly associated with the record system 350. The first user 322, second user 332, and/or third user 362 may communicate with the server system 312 to identify an occurrence of an event (e.g., first triggering event 260, second triggering event 270), evaluate a condition (e.g., first trigger condition 262, second trigger condition 272), and/or perform one or more operations (e.g., first triggered actions 264, second triggered actions 274). In some examples, the server system 312 stores and/or maintains the management data 346 at the cloud location 310 to demonstrate and/or substantiate that the first user 322, second user 332, and/or third user 362 are authorized to access or use account data associated with the user account 250.

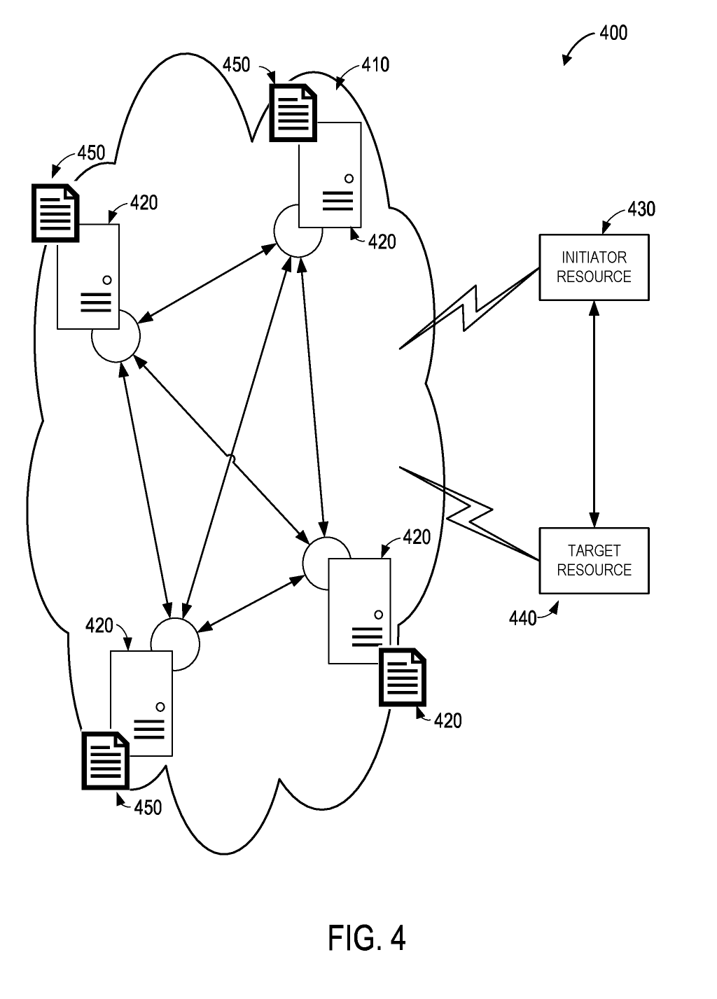

FIG. 4 is a block diagram illustrating an example participation management environment 400 operating as a cloud-based service using blockchain technology. The participation management environment 400 may be an illustrative example of the participation management environment 120 in FIG. 1 and/or the participation management environment 200 in FIG. 2. The participation management environment 400 may be implemented in a cloud-based environment, such as a distributed network 410, with one or more operations performed in the cloud. For example, one or more participation management operations, such as those depicted in FIGS. 2, 5, 6, and 7, may be performed at the distributed network 410.

The distributed network 410 may be communicatively coupled to one or more computing systems or resources (e.g., computing device 100, user device 150, server system 312, first client device 320, second client device 330, record system 350, third client device 360) in a monitored system via a communication network (e.g., communication network 140). The distributed network 410 includes a plurality of nodes 420 that use one or more server-side applications to provide one or more client-side services at the resources. Additionally, or alternatively, a resource may use one or more client-side applications to present and/or obtain information while participation management operations are performed on the backend at a node 420.

A resource in the monitored system may be associated with one or more roles and, thus, is associated with a single role in the context of a single corresponding transaction. An initiator resource 430 may be used to transmit a request message to a target resource 440. The request message may be transmitted to initiate or start a session between the initiator resource 430 and the target resource 440. In some examples, the request message is associated with managing participation of a user associated with the target resource 440 (e.g., participant 102). Alternatively, the request message may be associated with an agreement to participate in the monitored system and/or a user's consent to be monitored in the monitored system. The target resource 440 processes the request message and, in some examples, transmits a response message to the initiator resource 430. The request message may be analyzed to determine whether to approve or not approve the request message.

In some examples, the initiator resource 430 and/or target resource 440 generates a transaction request 220 associated with a transfer between a plurality of users (e.g., first user 322, second user 332), and broadcasts the transaction request 220 to the distributed network 410. In this manner, one or more nodes 420 in the distributed network 410 may obtain the transaction request 220. Upon obtaining the transaction request 220, a node 420 processes the transaction request 220 to generate transaction data 450 (e.g., first transaction data 242, second transaction data 246) and broadcasts the transaction data 450 to the distributed network 410. Each node 420 that obtains a transaction request 220 may independently process the transaction request 220 to generate an instance of the transaction data 450. In this manner, a node 420 may transmit an instance of the transaction data 450 that is local to that node 420 (e.g., a local instance) to one or more other nodes 420 and/or receive one or more instances of the transaction data 450 that are local to one or more other nodes 420 (e.g., one or more remote instances) from those other nodes 420. A node 420 may be configured to broadcast transaction data 450 that is new to that node 420. For example, the node 420 may broadcast transaction data 450 generated at that node 420 and/or rebroadcast transaction data 450 received from one or more other nodes 420.

The nodes 420 in the distributed network 410 record or register transaction data 450 in a record or ledger (e.g., ledger 240). In some examples, transaction data 450 includes data associated with a fulfilled data request. For example, the ledger 240 may include a record of who accessed or viewed the ledger 240. Each node 420 that generates and/or receives transaction data 450 may independently register the transaction data 450 in a ledger 240 that is local to that node 420. In some examples, the node 420 uses a transaction identifier associated with the transaction data 450 to determine whether to register the transaction data 450. The transaction identifier may include a public key, a representation of the public key (e.g., an encrypted key, a hash, an encrypted hash), and/or a link to the public key associated with the first user 322 and/or second user 332.

If the ledger 240 does not include an instance of the transaction data 450 (e.g., the ledger 240 does not include transaction data associated with a transaction identifier that corresponds to or matches the transaction identifier associated with the transaction data 450), the node 420 registers the transaction data 450 in the ledger 240. On the other hand, if the ledger 240 includes an instance of the transaction data 450, the node 420 implements a consensus protocol 248 to determine whether to accept, reject, or modify the transaction data in the ledger 240 and/or the transaction data 450. If there is consensus among the nodes 420 in the distributed network 410, a transaction 244 associated with the transaction data 450 may be validated.

To facilitate controlling or managing the transaction data 450 in a transparent and verifiable manner, the transaction 244 may be recorded in the ledger 240 using blockchain technology. Recording the transaction 244 in the ledger 240 may allow one or more users to access or use a transaction history associated with a participant 102. For example, transaction data 450 in a blockchain may be used to demonstrate and/or substantiate that one or more members of the monitored system are authorized to access or use account information associated with the participant 102. In some examples, the ledger 240 is used to demonstrate and/or substantiate that the asset 104 associated with the transaction 244 is legitimate, that the parties to the transaction 244 (e.g., first user 322, second user 332) have the capacity or authority to enter into the transaction 244, and/or that the parties agree to enter into the transaction 244. Additionally, the ledger 240 may also be used to demonstrate and/or substantiate who accessed or viewed the records.

A plurality of transactions may be chained together in chronological order to form a block. For example, an input to a transaction may be associated with an output from a previous transaction, and/or an output from a transaction may be associated with an input to a subsequent transaction. In some examples, an output from a transaction may be spent or used once. For example, upon using an output from a transaction as an input to another transaction, the output may be identified or recognized as being spent. Using a spent output as an input to a transaction may render the transaction invalid (e.g., the transaction may be rejected). In some examples, an output may be partitioned for use as an input to a plurality of transactions, and/or a plurality of outputs may be combined for use as an input to a single transaction.

A plurality of blocks may be chained together in chronological order to form a blockchain. A block includes a block header and a hash of a previous block's block header. Additionally, the block header may be hashed and stored in a subsequent block. The block header may include an identifier associated with one or more transactions in the block. In some examples, the transactions in a block are iteratively hashed and paired to generate the identifier (e.g., a merkle root of a merkle tree).

The blocks may be traversed in reverse chronological order to validate one or more transactions in the blockchain. A proof of work, for example, may be used to demonstrate and/or substantiate that one or more operations were performed to validate a transaction and/or generate a block. Transaction data 450 associated with the transaction 244 may be analyzed to check that a local version of the blockchain is in sync with other versions in the distributed network 410. If the distributed network 410 includes a plurality of versions of the blockchain, a consensus protocol 248 may be implemented to identify a valid version. The valid version may be identified based on a block height or length.

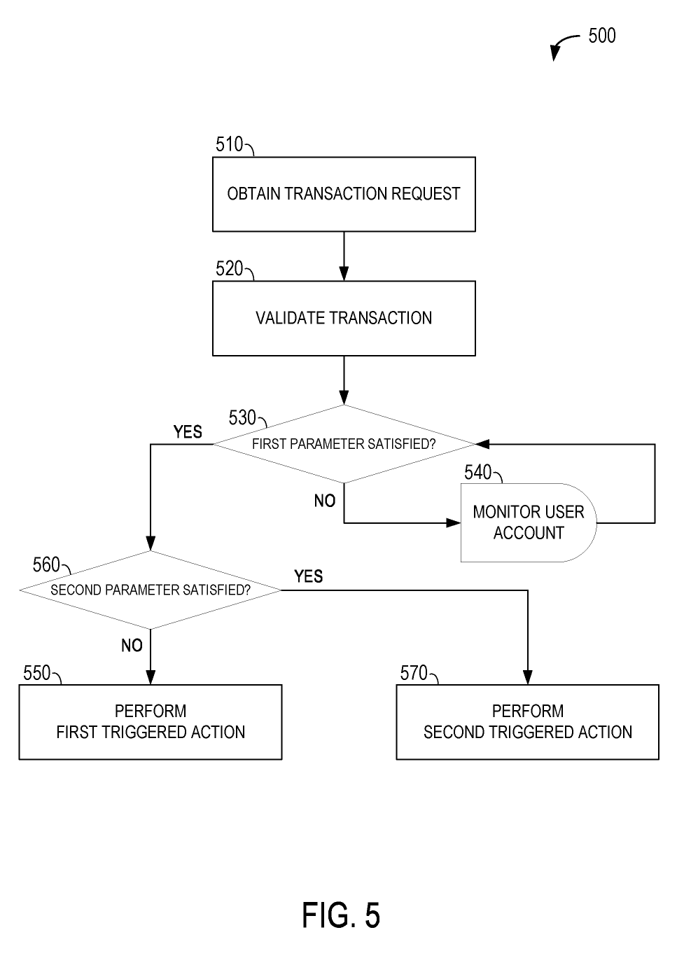

FIG. 5 is a flowchart illustrating an example method 500 for managing participation in a monitored system. The method 500 may be implemented at the computing device 100. For example, the method 500 may be implemented using the participation management environment 120 in FIG. 1 and/or the participation management environment 200 in FIG. 2. Additionally, the method 500 may be implemented in the participation management environment 300 in FIG. 3 and/or the participation management environment 400 in FIG. 4.

A transaction request 220 is obtained at operation 510. The transaction request 220 is associated with a transfer of an asset 104 between a participant 102 and a system registrar of the monitored system. The asset 104 may be representative of a participant's consent to be monitored in the monitored system. In some examples, the asset 104 includes authorization data 254 and event condition action data 256 associated with the authorization data 254. The authorization data 254 may be associated with an authorization of one or more members of the monitored system to perform one or more authorized tasks associated with the participant 102, and the event condition action data 256 may define at least some parameters for performing the authorized tasks in accordance with the authorization data 254. In some examples, the transaction request 220 is received from a user device associated with a participant 102 (e.g., second client device 330) or from a user device associated with a system registrar of the monitored system (e.g., first client device 320). Alternatively, the transaction request 220 may be received from any computing system that enables the computing device 100 to function as described herein.

A transaction 244 associated with the transfer of the asset 104 is validated at operation 520. In some examples, the computing device 100 communicates with one or more nodes 420 in a distributed network 410 to validate the transaction 244. For example, the computing device 100 may transmit first transaction data 242 to one or more nodes 420 and/or receive or retrieve second transaction data 246 from one or more nodes 420 to enable the first transaction data 242 to be compared with the second transaction data 246 for validating the transaction 244. Broadcasting the transaction data to the distributed network 410 enables a public ledger, including an ordered and timestamped record of the transaction 244, to be generated. In some examples, the computing device 100 transmits a confirmation of the transaction 244 to the user device associated with the participant 102 (e.g., second client device 330) or from the user device associated with the system registrar (e.g., first client device 320).

The computing device 100 administers or manages data associated with the participant 102. For example, the computing device 100 facilitates monitoring a user account 250 associated with the participant 102 in accordance with the authorization data 254. In some examples, the computing device 100 transmits one or more keys to one or more client devices associated with the members (e.g., third client device 360). The keys may be used or configured to authenticate the members for authorizing the members to access the user account 250.

On condition that a predetermined first parameter is identified at operation 530 to be not satisfied, the user account 250 is monitored at operation 540 in accordance with the authorization data 254. If, however, the predetermined first parameter is identified at operation 530 to be satisfied, a first trigger is executed to perform at operation 550 one or more first triggered actions 264, based upon an evaluation of a predetermined second parameter as discussed below. First triggered actions 264 may include communicating with one or more nodes 420 to validate a first triggered transaction associated with a transfer of another asset (e.g., a second asset) between the participant 102 and a member (e.g., a first member) of the monitored system. The first triggered transaction may be associated with one or more tasks authorized in accordance with the authorization data 254. In some examples, the computing device 100 transmits an instruction to perform the transfer of the second asset to a third client device 360 associated with the first member.

In some examples, the computing device 100 executes the first trigger on condition that a predetermined second parameter is identified at operation 560 to be not satisfied. The predetermined second parameter may be a time-based parameter associated with the authorization data 254. In some examples, the computing device 100 systematically (e.g., with each instance a predetermined first parameter is satisfied) determines whether the predetermined second parameter is satisfied (as shown in FIG. 5). Alternatively, the computing device 100 may periodically (e.g., at predetermined time intervals) determine whether the predetermined second parameter is satisfied.

On condition that the predetermined second parameter is identified at operation 560 to be satisfied, a second trigger is executed to perform at operation 570 one or more second triggered actions 274. Second triggered actions 274 may include communicating with one or more nodes 420 to validate a second triggered transaction associated with another transfer (e.g., a second transfer) of the asset 104 between the participant 102 and the system registrar. The second triggered transaction may be associated with a revocation of the authorization of the members of the monitored system to perform one or more authorized tasks. In some examples, the computing device 100 transmits an instruction to perform the second transfer of the asset 104 to the first client device 320 and/or second client device 330.

The computing device 100 may determine whether the predetermined first parameter and/or second predetermined parameter are satisfied upon identifying that the second client device 330 is coupled to one or more nodes 420. On condition that the predetermined first parameter and the predetermined second parameter are satisfied, a first time associated with the first predetermined parameter being satisfied and a second time associated with the second predetermined parameter being satisfied are identified or determined. If the first time is before (e.g., earlier than) the second time, the computing device 100 executes the first trigger to perform the first triggered actions 264, and transmits a notification of the first predetermined parameter being satisfied and/or a confirmation of the first triggered transaction being validated to the first client device 320, second client device 330, and/or third client device 360. On the other hand, if the first time is not before the second time, the computing device 100 executes the second trigger to perform the second triggered actions 274, and transmits a notification of the second predetermined parameter being satisfied and/or a confirmation of the second triggered transaction being validated to the first client device 320, second client device 330, and/or third client device 360.

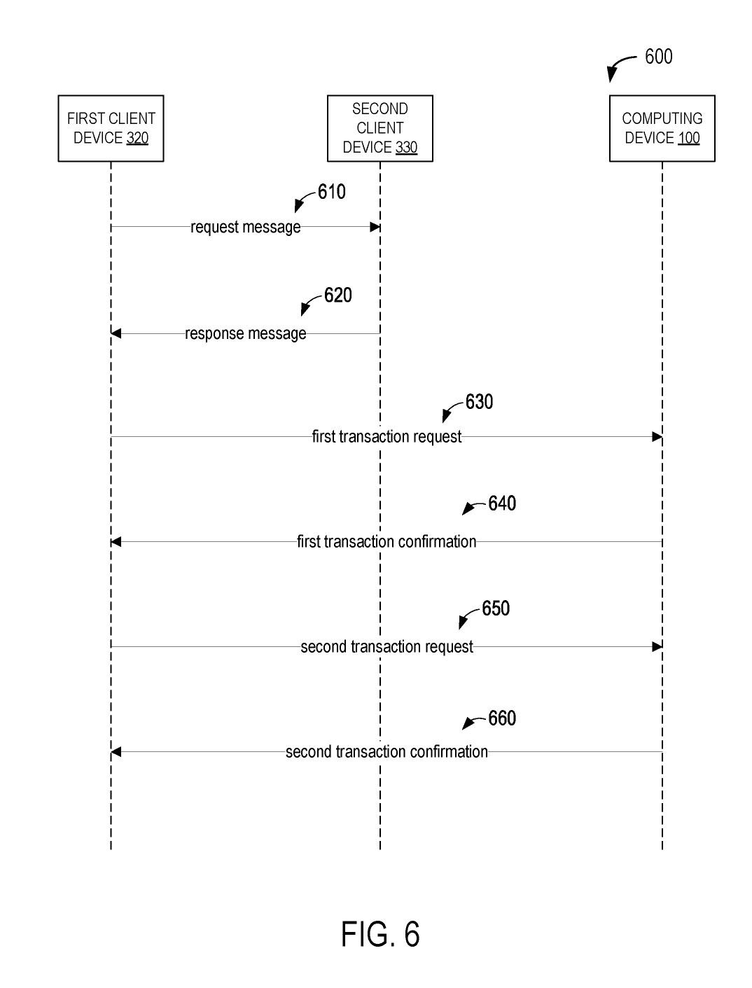

FIG. 6 is a sequence diagram illustrating an example method 600 for managing participation in a monitored system. The method 600 may be implemented using the participation management environment 120 in FIG. 1 and/or the participation management environment 200 in FIG. 2. The method 600 may be used, for example, to give user consent to be monitored in the monitored system. Additionally, the method 600 may be implemented in the participation management environment 300 in FIG. 3 and/or the participation management environment 400 in FIG. 4.

A client device associated with a system registrar (e.g., first client device 320) transmits at operation 610 a request message to a computing device associated with a participant 102 (e.g., second client device 330). In some examples, the first client device 320 communicates directly with the second client device 330. Alternatively, the first client device 320 may communicate with the second client device 330 via one or more nodes 420 in a distributed network 410. The request message may initiate or start a session between the first client device 320 and the second client device 330. The second client device 330 processes or analyzes the request message to determine whether to approve or not approve the request message. In some examples, the second client device 330 transmits at operation 620 a response message to the first client device 320. The response message may include a public key associated with the participant 102, a representation of the public key (e.g., an encrypted key, a hash, an encrypted hash), and/or link to the public key.

The session includes one or more transactions associated with one or more participation management actions. The first client device 320 may transmit a first transaction request (e.g., transaction request 220) to a computing device 100 at operation 630, and receive a first transaction confirmation from the computing device 100 at operation 640. In some examples, the first client device 320 communicates with the computing device 100 and/or second client device 330 to administer or manage data associated with the participant 102. For example, the first client device 320 facilitates monitoring a user account 250 associated with the participant 102 in accordance with the authorization data 254.

In some examples, the first client device 320 transmits a second transaction request to the nodes 420 at operation 650, and receive a second transaction confirmation from the nodes 420 at operation 660. Alternatively, the second transaction request may be transmitted from and/or the second transaction conformation may be transmitted to the second client device 330 and/or one or more third client devices 360 associated with one or more members of the monitored system. While the example session includes two transactions, the session may include any number of transactions that enable the monitored system to function as described herein.

The second transaction request may be associated with a transfer of a second asset between the participant 102 and a first member of the monitored system. Additionally, or alternatively, the second transaction request may be associated with a second transfer of the asset 104 between the participant 102 and the system registrar. In some examples, the second transaction request includes a notification of the first predetermined parameter being satisfied and/or a notification of the second predetermined parameter being satisfied. The second transaction request may be transmitted, for example, upon detecting an occurrence of a triggering event (e.g., first triggering event 260, second triggering event 270) and/or on condition that a trigger condition (e.g., first trigger condition 262, second trigger condition 272) is satisfied.

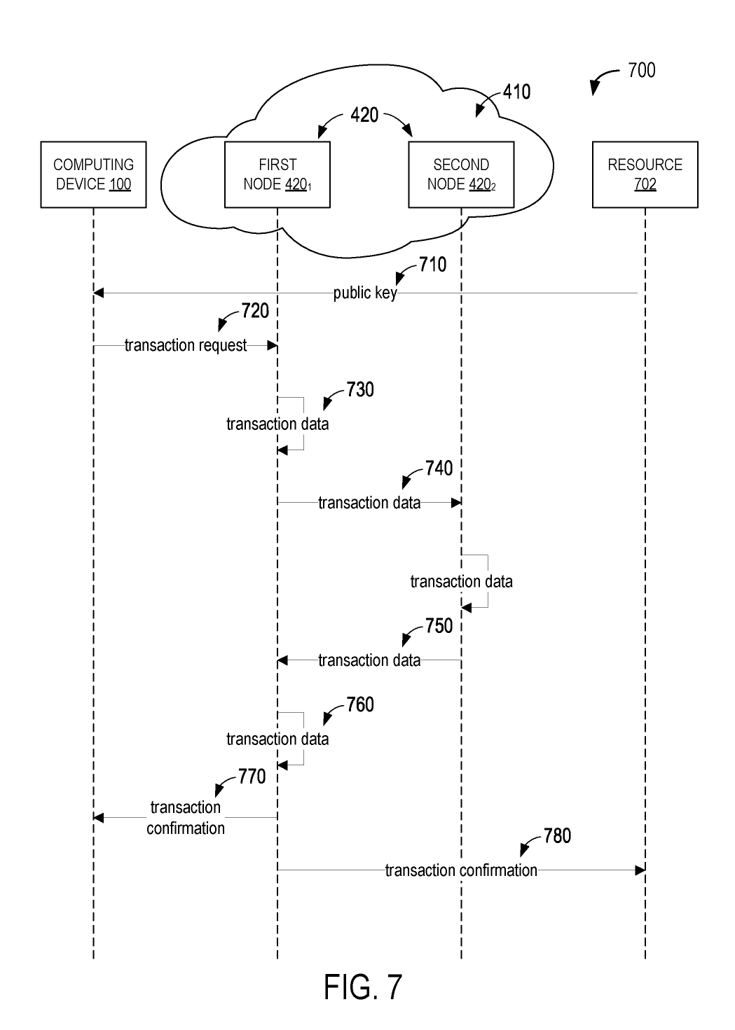

FIG. 7 is a sequence diagram illustrating an example method 700 for managing participation in a monitored system using a distributed network 410. The method 700 may be implemented using the participation management environment 120 in FIG. 1 and/or the participation management environment 200 in FIG. 2 in the participation management environment 400 in FIG. 4. Additionally, the method 700 may be implemented in the participation management environment 300 in FIG. 3 and/or the participation management environment 400 in FIG. 4. The method 700 may be used, for example, to record or register transaction data in a public ledger.

A computing device 100 may receive at operation 710 an identifier from a resource 702, such as an initiator resource 430 and/or a target resource 440 (e.g., first client device 320, second client device 330). The identifier may include, for example, a public key associated with the participant 102, a representation of the public key (e.g., an encrypted key, a hash, an encrypted hash), and/or link to the public key. The computing device 100 uses the identifier to generate a transaction request 220 associated with a transfer of an asset 104 between the participant 102 and a system registrar. The asset 104 may include, for example, authorization data 254 and event condition action data 256 associated with the authorization data 254.

The computing device 100 generates a transaction request 220 associated with a transfer between a participant 102 and a system registrar. In some examples, the computing device 100 transmits at operation 720 the transaction request 220 to a first node 420₁ of a plurality of nodes 420, and the first node 420₁ broadcasts the transaction request 220 to a distributed network 410 including the nodes 420 to enable the nodes 420 to obtain the transaction request 220. Alternatively, the computing device 100 and/or resource 702 may broadcast the transaction request 220 to the distributed network 410.

Upon receiving the transaction request 220, the first node 420₁ analyzes the transaction request 220 to generate transaction data 450, and registers at operation 730 the transaction data 450 in a ledger (e.g., ledger 240). The first node 420₁ broadcasts the transaction data 450 to the distributed network 410 for validating the transaction data 450. For example, the transaction data 450 may be transmitted at operation 740 to a second node 420₂ of the plurality of nodes 420. If the first node 420₁ receives at operation 750 a remote instance of the transaction data 450 from the second node 420₂, the first node 420₁ analyzes the transaction data 450 to validate at operation 760 the transaction data 450. In some examples, the first node 420₁ generates and transmits at operation 770 a response to the transaction request to the computing device 100. The response may include a transaction confirmation. Additionally, or alternatively, the first node 420₁ may generate and/or transmit at operation 780 a transaction confirmation to the resource 702.

The transaction 244 may be administered or managed in accordance with one or more interests associated with the asset 104. For example, the transaction 244 may be managed and/or monitored in accordance with authorization data 254 and event condition action data 256. The examples described herein allow a participant 102 to check in with a program registrar systematically (e.g., with an occurrence of a predetermined event, when in a predetermined check in zone, using a predetermined user device, at a predetermined time) and/or periodically (e.g., at predetermined time intervals).

For a period of time after the participant 102 has checked in (e.g., initiated a session), the program registrar is allowed to determine whether the participant 102 is in compliance with the monitored system. The public ledger, for example may be used to access or analyze data associated with the participant 102. In some examples, user consent is given using a smart contract in which the participant 102 agrees to enter into one or more conditional transactions. For example, if the participant 102 is not in compliance with the monitored system, the program registrar may allow or authorize one or more members of the monitored system to modify, buyback, or annul an insurance policy; suspend or revoke a driver's license; and/or issue a citation, ticket, charging document, and/or court decision. The examples described herein may be used, for example, without limitation, to administer or manage one or more insurance policies, driver's licenses, smart car operator licenses, and/or probation or parole programs.

In other examples, the participant may be a device, such as a kiosk used for controlled receipt of packages, such as those packages delivered autonomously via unmanned aerial vehicle (UAV) or automated guided vehicle (AGV). In this illustrative example, a user may obtain a kiosk and add the newly obtained kiosk to the distributed ledger structure utilizing their smart device to provision and/or authorize the kiosk. In one example, the user device may be a wearable device that maintains the private key used to authorize the transaction. The kiosk may sync with the user device and be automatically provisioned as a home delivery station and added as a device in the distributed ledger management system. A user may configure customized levels of access and/or control for the kiosk, such as the ability to accept or decline a package or the ability to create and order an item, and so on, via the management environment (e.g. appliance management environment 120). The device may also be preloaded or preconfigured with device logic for customized levels of control and access, based on user preferences. In this way, the device as a participant may be monitored for compliance, and provisioned and/or deprovisioned as triggered by the compliance parameters configured for the participant.

In addition, a user may view and modify levels of control and access of devices provisioned and/or deprovisioned in the system. For example, if the user obtains a new device, replacement device, or updated device (e.g. a new kiosk to replace an existing kiosk), an existing device may be automatically removed, or deprovisioned, from the management system on the distributed ledger. This enables a user to dynamically control and modify the levels of access and control for each device on the system. As another example, a user may modify a level of access for dedicated or pre-defined time intervals, such as disabling a kiosk's ability to accept a package when the user is away on vacation.

The system and methods provided herein enable a user to access and view historical data pertaining to device actions, decisions, and the like, which are saved in the distributed ledger. All actions, negotiations, transactions, and interactions made by the device generate subsequent blocks stored in the chain of the distributed ledger. This enables a user to view previous interactions and transactions made by a device at their discretion.

In other examples, such as with a fleet management system, as vehicles in the fleet are added or removed, this information may be controlled and updated through the distributed ledger system. As one example, a new UAV is obtained for a fleet and is granted a private key. Once the private key granted to the new UAV and the UAV exists on the distributed ledger, the UAV is added to the fleet management system, and levels of access, control, and/or authority are determined for the new UAV. As updates are needed for the UAV, such as software updates for example, the fleet management system operating on the distributed ledger system may receive information from the UAV manufacturer on a required update. The UAV may be granted the control or ability to automatically perform software updates and notify the fleet management system after it has completed the update, for example. As another example, as maintenance is needed for the UAV, the UAV may distribute information to the fleet management system on this activity to display the UAV status as inoperable on the fleet management system until after maintenance is completed. Once completed, the UAV may provide information to the fleet management system on its operational capacity, thereby allowing the UAV to be used as needed by the fleet management system and updating the status back to operable. In yet another example, as a vehicle is retired or replaced, the fleet management system operating on the distributing ledger system may deprovision the vehicle and the levels of access for that vehicle as well.

The examples and illustrations provided herein may apply to autonomous ground vehicles, human operated vehicles, autonomous aircraft, robotic vehicles, and/or any other suitable vehicle or transport device.

Alternatively, or in addition to the other examples described herein, examples include any combination of the following:
identifying a transaction request associated with a transfer of an asset;
identifying an asset associated with event condition action data and authorization data;
identifying a network including one or more nodes;
communicating with one or more nodes in a network to validate a transaction;
identifying a response to a transaction request including a validation notification;
identifying a validation notification associated with a transfer of an asset;
providing one or more keys configured to authenticate one or more members for authorizing the members to access a user account associated with a participant;
determining whether a client device associated with a participant is coupled to one or more nodes in a network;
detecting an occurrence of a triggering event associated with a trigger;
evaluating a trigger condition associated with a trigger to determine whether a parameter is satisfied;
identifying a notification of a parameter being satisfied;
determining whether a first parameter and/or a second parameter is satisfied;
determining a time associated with a parameter being satisfied;
executing a trigger to perform one or more triggered actions including communicating with one or more nodes in a network to validate a triggered transaction;
identifying a confirmation of a transaction;
a client component that, upon execution by at least one processor, receives a first transaction request, and transmits a response to the first transaction request, the first transaction request associated with a first transfer of a first asset between the participant and a system registrar;
a client component configured to transmit an instruction to perform the transfer of the second asset;
a client component configured to transmit an instruction to perform the second transfer of the first asset;
a consensus component that, upon execution by the at least one processor, generates a local instance of the first transaction request, transmits the local instance of the first transaction request to one or more nodes in a network, receives one or more remote instances of the first transaction request from the one or more nodes in the network, and implements a consensus protocol to validate a transaction associated with the first transfer of the first asset;
a manager component that, upon execution by the at least one processor, associates the first asset with a user account associated with the participant, the first asset including authorization data associated with an authorization of one or more members of a monitored system to perform one or more authorized tasks;
a manager component configured to transmit one or more keys, authenticate the one or more members based on the one or more keys, and authorize the one or more members to access the user account associated with the participant;
a manager component configured to transmit one or more keys, authenticate the one or more members based on the one or more keys, and transmit an instruction to perform the transfer of the second asset;
a manager component configured to transmit one or more keys, authenticate the one or more members based on the one or more keys, and authorize the one or more members to transmit a second transaction request, the second transaction request associated with the transfer of the second asset;
a first trigger component that, upon execution by the at least one processor, monitors the user account associated with the participant, and, if a first triggering event is detected, determines whether a transfer of a second asset between the participant and a first member of the one or more members is to be performed for enforcing the monitored system;
a first trigger component configured to evaluate one or more of an event-based condition, a location-based condition, or a time-based condition; and
a second trigger component that, upon execution by the at least one processor, monitors a time-based parameter, and, if a second triggering event is detected, determines whether a second transfer of the first asset between the participant and the system registrar is to be performed for revoking the authorization of the one or more members to perform the one or more authorized tasks.

In some examples, the operations illustrated in FIGS. 2, 5, 6, and 7 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure. Moreover, while at least some examples of the disclosure are directed to a participation management environment, aspects of the disclosure may be provided in a variety of environments in which a user is monitored.

Examples have been described with reference to data monitored and/or collected from the users. Notice is provided to the users of the collection of the data (e.g., via a dialog box or preference setting) and users are given the opportunity to give or deny consent for the monitoring and/or collection. The consent may take the form of opt-in consent or opt-out consent, for example.

### Example Operating Environment

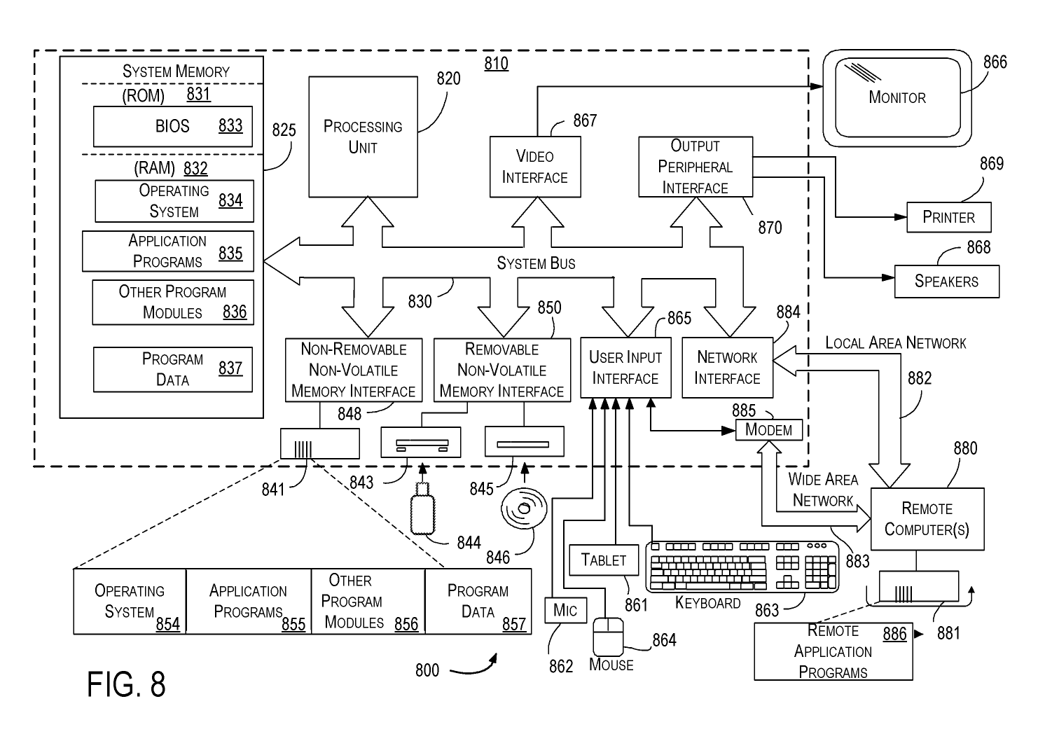

FIG. 8 is a block diagram illustrating an example operating environment 800 for a computing device (e.g., computing device 100). The computing system environment 800 is only one example of a suitable computing environment and is not intended to suggest any limitation as to the scope of use or functionality of the disclosure. Neither should the computing environment 800 be interpreted as having any dependency or requirement relating to any one or combination of components illustrated in the example operating environment 800.

The disclosure is operational with numerous other general purpose or special purpose computing system environments or configurations. Examples of well-known computing systems, environments, and/or configurations that may be suitable for use with the disclosure include, but are not limited to: personal computers, desktop computers, laptop computers, tablet devices, netbooks, handheld devices, mobile telephones, wearables, gaming devices, portable media players, server computers, kiosks, set top boxes, tabletop devices, multiprocessor systems, microprocessor-based systems, programmable consumer electronics, network PCs, minicomputers, mainframe computers, distributed computing environments that include any of the above systems or devices, and the like.

The disclosure may be described in the general context of computer-executable instructions, such as program modules, being executed by a computer. Generally, program modules include routines, programs, objects, components, data structures, and so forth, which perform particular tasks or implement particular abstract data types. The disclosure may also be practiced in distributed computing environments where tasks are performed by remote processing devices that are linked through a communications network. In a distributed computing environment, program modules may be located in local and/or remote computer storage media including memory storage devices and/or computer storage devices. As used herein, computer storage devices refer to hardware devices.

With reference to FIG. 8, an example system for implementing various aspects of the disclosure may include a general purpose computing device in the form of a computer 810. Components of the computer 810 may include, but are not limited to, a processing unit 820, a system memory 825, and a system bus 830 that couples various system components including the system memory to the processing unit 820. The system bus 830 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 810 typically includes a variety of computer-readable media. Computer-readable media may be any available media that may be accessed by the computer 810 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or the like. Read only memory (ROM) 831 and random access memory (RAM) 832 are examples of computer storage media. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by the computer 810. Computer storage media does not, however, include propagated signals. Rather, computer storage media excludes propagated signals. Any such computer storage media may be part of computer 810.

Communication media typically embodies computer-readable instructions, data structures, program modules or the like in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The system memory 825 includes computer storage media in the form of volatile and/or nonvolatile memory such as ROM 831 and RAM 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs, such as application programs 835 (e.g., participation management environment), other program modules 836 and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a universal serial bus (USB) port 843 that provides for reads from or writes to a removable, nonvolatile memory 844, and an optical disk drive 845 that reads from or writes to a removable, nonvolatile optical disk 846 such as a CD ROM or other optical media. Other removable/non-removable, volatile/nonvolatile computer storage media that may be used in the example operating environment include, but are not limited to, magnetic tape cassettes, flash memory cards, digital versatile disks, digital video tape, solid state RAM, solid state ROM, and the like. The hard disk drive 841 is typically connected to the system bus 830 through a non-removable memory interface such as interface 848, and USB port 843 and optical disk drive 845 are typically connected to the system bus 830 by a removable memory interface, such as interface 850.

The drives and their associated computer storage media, described above and illustrated in FIG. 8, provide storage of computer-readable instructions, data structures, program modules and other data for the computer 810. In FIG. 8, for example, hard disk drive 841 is illustrated as storing operating system 854, application programs 855 (e.g., a participation management environment), other program modules 856 and program data 857. Note that these components may either be the same as or different from operating system 834, application programs 835, other program modules 836, and program data 837. Operating system 854, application programs 855, other program modules 856, and program data 857 are given different numbers herein to illustrate that, at a minimum, they are different copies.

A user may enter commands and information into the computer 810 through input devices such as a tablet, or electronic digitizer, 861, a microphone 862, a keyboard 863 and pointing device 864, commonly referred to as mouse, trackball or touch pad. Other input devices not shown in FIG. 8 may include a joystick, game pad, digital camera, scanner, or the like. These and other input devices are often connected to the processing unit 820 through a user input interface 865 that is coupled to the system bus, but may be connected by other interface and bus structures, such as a parallel port, game port or a universal serial bus (USB). A monitor 866 or other type of display device is also connected to the system bus 830 via an interface, such as a video interface 867. The monitor 866 may also be integrated with a touchscreen panel or the like. Note that the monitor and/or touchscreen panel may be physically coupled to a housing in which the computing device 810 is incorporated, such as in a tablet device. In addition, computers such as the computing device 810 may also include other peripheral output devices such as speakers 868 and printer 869, which may be connected through an output peripheral interface 870 or the like.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include one or more local area networks (LAN) 882 and one or more wide area networks (WAN) 883, but may also include other networks. Such networking environments are commonplace in offices, enterprise-wide computer networks, intranets and the Internet.

When used in a LAN networking environment, the computer 810 is connected to the LAN 882 through a network interface controller or adapter 884. When used in a WAN networking environment, the computer 810 typically includes a modem 885 or other means for establishing communications over the WAN 883, such as the Internet. The modem 885, which may be internal or external, may be connected to the system bus 830 via the user input interface 860 or other appropriate mechanism. A wireless networking component such as comprising an interface and antenna may be coupled through a suitable device such as an access point or peer computer to a WAN or LAN. In a networked environment, program modules depicted relative to the computer 810, or portions thereof, may be stored in the remote memory storage device. By way of example, and not limitation, FIG. 8 illustrates remote application programs 885 as residing on memory device 881. It may be appreciated that the network connections shown are exemplary and other means of establishing a communication link between the computers may be used.

The examples illustrated and described herein as well as examples not specifically described herein but within the scope of aspects of the disclosure constitute an example participation management environment. For example, the elements illustrated in FIGS. 1-4 and 6-8, such as when encoded to perform the operations illustrated in FIGS. 2 and 5-7, constitute an example means for obtaining a transaction request associated with a transfer of an asset between a participant and a system registrar of a monitored system (e.g., client module 122, client component 202); an example means for communicating with one or more nodes in a network to validate a transaction (e.g., registration module 126, manager module 130, trigger module 132, registration component 206, manager component 210, first trigger component 212, second trigger component 214); and an example means for executing a trigger to perform one or more triggered actions including communicating with one or more nodes in the network to validate a triggered transaction (e.g., registration module 126, consensus module 128, manager module 130, trigger module 132, registration component 206, consensus component 208, manager component 210, first trigger component 212, second trigger component 214).

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

What is claimed is:

1. A computer-implemented method for managing participation in a monitored system, the computer-implemented method comprising:
obtaining a first transaction request, the first transaction request associated with a first transfer of a first asset between a participant and a system registrar of the monitored system, the first asset associated with event condition action data and authorization data, the event condition action data associated with a first trigger configured to execute on condition that a predetermined first parameter is satisfied and a second trigger configured to execute on condition that a predetermined second parameter is satisfied, the authorization data associated with an authorization of one or more members of the monitored system to perform one or more authorized tasks;
communicating with one or more nodes in a network to validate a first transaction, the first transaction associated with the first transfer of the first asset;
upon identifying that the predetermined first parameter is satisfied, executing the first trigger to perform one or more first triggered actions including communicating with the one or more nodes in the network to validate a first triggered transaction, the first triggered transaction associated with a transfer of a second asset between the participant and a first member of the one or more members; and
upon identifying that the predetermined second parameter is satisfied, executing the second trigger to perform one or more second triggered actions including communicating with the one or more nodes in the network to validate a second triggered transaction, the second triggered transaction associated with a second transfer of the first asset between the participant and the system registrar, the second transfer associated with a revocation of the authorization.

2. The computer-implemented method of claim 1, further comprising providing a confirmation of the first transaction.

3. The computer-implemented method of claim 1, further comprising providing one or more keys configured to authenticate the one or more members for authorizing the one or more members to access a user account associated with the participant.

4. The computer-implemented method of claim 1, further comprising:
obtaining a second transaction request, the second transaction request associated with the transfer of the second asset between the participant and the first member, the second transaction request including a notification of the predetermined first parameter being satisfied;
communicating with the one or more nodes in the network to validate a second transaction, the second transaction associated with the transfer of the second asset; and
providing a confirmation of the second transaction.

5. The computer-implemented method of claim 1, further comprising:
obtaining a second transaction request, the second transaction request associated with the second transfer of the first asset between the participant and the system registrar, the second transaction request including a notification of the predetermined second parameter being satisfied;
communicating with the one or more nodes in the network to validate a second transaction, the second transaction associated with the second transfer of the first asset; and
providing a confirmation of the second transaction.

6. The computer-implemented method of claim 1, further comprising:
detecting an occurrence of a triggering event associated with the first trigger;
evaluating a trigger condition associated with the first trigger to determine whether the predetermined first parameter is satisfied; and
on condition that the predetermined first parameter is satisfied:
communicating with the one or more nodes in the network to validate a second transaction, the second transaction associated with the transfer of the second asset,
providing a notification of the predetermined first parameter being satisfied, and
providing a confirmation of the second transaction.

7. The computer-implemented method of claim 1, further comprising:
detecting an occurrence of a triggering event associated with the second trigger;
evaluating a trigger condition associated with the second trigger to determine whether the predetermined second parameter is satisfied; and
on condition that the predetermined second parameter is satisfied:
communicating with the one or more nodes in the network to validate a second transaction, the second transaction associated with the second transfer of the first asset,
providing a notification of the predetermined second parameter being satisfied, and
providing a confirmation of the second transaction.

8. The computer-implemented method of claim 1, further comprising:
determining whether a client device associated with the participant is coupled to the one or more nodes in the network;
on condition that the client device is coupled to the one or more nodes in the network, determining whether one or more of the predetermined first parameter or the predetermined second parameter is satisfied;
on condition that the predetermined first parameter is satisfied and the predetermined second parameter is satisfied, determining a first time associated with the predetermined first parameter being satisfied, and determining a second time associated with the predetermined second parameter being satisfied;
on condition that the first time is before the second time:
communicating with the one or more nodes in the network to validate a second transaction, the second transaction associated with the transfer of the second asset,
providing a notification of the predetermined second parameter being satisfied, and
providing a confirmation of the second transaction; and
on condition that the first time is not before the second time:
communicating with the one or more nodes in the network to validate a third transaction, the third transaction associated with the second transfer of the first asset,
providing a notification of the predetermined second parameter being satisfied, and
providing a confirmation of the third transaction.

9. A computing system for managing participation in a monitored system, the computing system comprising:
a memory device storing data associated with a participant and computer-executable instructions; and
a processor configured to execute the computer-executable instructions to:
identify a first asset associated with event condition action data and authorization data, the event condition action data associated with a first trigger configured to execute on condition that a predetermined first parameter is satisfied and a second trigger configured to execute on condition that a predetermined second parameter is satisfied, the authorization data associated with an authorization of one or more members of the monitored system to perform one or more authorized tasks;
identify a network including one or more nodes;
transmit, to the one or more nodes, a first transaction request, the first transaction request associated with a first transfer of the first asset between the participant and a system registrar associated with the monitored system;
receive, from the one or more nodes, a response to the first transaction request, the response including a first validation notification, the first validation notification associated with the first transfer of the first asset;
on condition that the predetermined first parameter is satisfied, receive, from the one or more nodes, a second validation notification, the second validation notification associated with a transfer of a second asset between the participant and a first member of the one or more members; and
on condition that the predetermined second parameter is satisfied, receive, from the one or more nodes, a third validation notification, the third validation notification associated with a second transfer of the first asset between the participant and the first member.

10. The computing system of claim 9, wherein the processor is further configured to execute the computer-executable instructions to:
identify that the predetermined first parameter is satisfied; and
transmit, to the one or more nodes, a second transaction request, the second transaction request associated with the transfer of the second asset between the participant and the first member.

11. The computing system of claim 9, wherein the processor is further configured to execute the computer-executable instructions to:
identify that the predetermined second parameter is satisfied; and
transmit, to the one or more nodes, a second transaction request, the second transaction request associated with the second transfer of the first asset between the participant and the system registrar.

12. The computing system of claim 9, wherein the processor is further configured to execute the computer-executable instructions to receive, from the one or more nodes, a notification of the predetermined first parameter being satisfied.

13. The computing system of claim 9, wherein the processor is further configured to execute the computer-executable instructions to receive, from the one or more nodes, a notification of the predetermined second parameter being satisfied.

14. One or more computer storage media embodied with computer-executable instructions, the one or more computer storage media comprising:
a client component that, upon execution by at least one processor, receives a first transaction request, and transmits a response to the first transaction request, the first transaction request associated with a first transfer of a first asset between the participant and a system registrar;
a consensus component that, upon execution by the at least one processor, generates a local instance of the first transaction request, transmits the local instance of the first transaction request to one or more nodes in a network, receives one or more remote instances of the first transaction request from the one or more nodes in the network, and implements a consensus protocol to validate a transaction associated with the first transfer of the first asset;
a manager component that, upon execution by the at least one processor, associates the first asset with a user account associated with the participant, the first asset including authorization data associated with an authorization of one or more members of a monitored system to perform one or more authorized tasks;
a first trigger component that, upon execution by the at least one processor, monitors the user account associated with the participant, and, if a first triggering event is detected, determines whether a transfer of a second asset between the participant and a first member of the one or more members is to be performed for enforcing the monitored system; and
a second trigger component that, upon execution by the at least one processor, monitors a time-based parameter, and, if a second triggering event is detected, determines whether a second transfer of the first asset between the participant and the system registrar is to be performed for revoking the authorization of the one or more members to perform the one or more authorized tasks.

15. The one or more computer storage media of claim 14, wherein the client component is configured to transmit an instruction to perform the transfer of the second asset.

16. The one or more computer storage media of claim 14, wherein the client component is configured to transmit an instruction to perform the second transfer of the first asset.

17. The one or more computer storage media of claim 14, wherein the manager component is configured to transmit one or more keys, authenticate the one or more members based on the one or more keys, and authorize the one or more members to access the user account associated with the participant.

18. The one or more computer storage media of claim 14, wherein the manager component is configured to transmit one or more keys, authenticate the one or more members based on the one or more keys, and transmit an instruction to perform the transfer of the second asset.

19. The one or more computer storage media of claim 14, wherein the manager component is configured to transmit one or more keys, authenticate the one or more members based on the one or more keys, and authorize the one or more members to transmit a second transaction request, the second transaction request associated with the transfer of the second asset.

20. The one or more computer storage media of claim 14, wherein the first trigger component is configured to evaluate one or more of an event-based condition, a location-based condition, or a time-based condition.
